(19) United States
(12) Patent Application Publication
(10) Pub. No.: US 2021/0152832 A1
(43) Pub. Date: May 20, 2021

(54) RECONSTRUCTING TRANSFORMED DOMAIN INFORMATION IN ENCODED VIDEO STREAMS

(71) Applicant: Alibaba Group Holding Limited, George Town, KY (US)

(72) Inventors: Minghai QIN, Hangzhou (CN); Yen-kuang CHEN, Hangzhou (CN); Kai XU, Hangzhou (CN); Yuhao WANG, Hangzhou (CN); Fei SUN, Hangzhou (CN); Yuan XIE, Hangzhou (CN)

(21) Appl. No.: 16/684,294

(22) Filed: Nov. 14, 2019

(51) Int. Cl. H04N 19/137; H04N 19/159; H04N 19/625; H04N 19/176; G06N 20/00

(52) U.S. Cl. CPC H04N 19/137; H04N 19/159; G06N 20/00; H04N 19/176; H04N 19/625

(57) ABSTRACT

Discrete cosine transformation (DCT) information can be estimated from adjacent blocks of the same frame. DCT information can be estimated from different frames. Motion vectors can be used to track the position of objects in some frames of the video. For example, a stream of encoded frames is received; the encoded frames are entropy decoded and dequantized to produce DCT information for blocks of the frames; and DCT information for a block in a frame is determined using the DCT information produced from the entropy decoding and dequantizing for a different block.

### RELATED U.S. APPLICATIONS

This application is related to, and incorporates by reference in their entirety, the following pending U.S. patent applications: Attorney Docket No. BABA-A24876, “Techniques for Determining Importance of Encoded Image Components for Artificial Intelligence Tasks,” by Xu et al.; Attorney Docket No. BABA-A24877, “Techniques to Dynamically Gate Encoded Image Components for Artificial Intelligence Tasks,” by Xu et al.; and Attorney Docket No, BABA-A24879, “Using Selected Components of Frequency Domain Image Data in Artificial Intelligence Tasks,” by Wang et al.

### BACKGROUND

When digital image or video frames are encoded (compressed), the frames of data are decomposed into macroblocks, each of which contains an array of blocks. Each of the blocks contains an array of pixels in the spatial (e.g., red (R), green (G), and blue (B)) domain. A discrete cosine transform (DCT) is performed to convert each block into the frequency domain. In quantization, the amount of frequency information is reduced so that fewer bits can be used to describe the image/video data, After quantization, the compression process concludes with entropy encoding (e.g., run-length encoding such as Huffman encoding) to encode and serialize the quantized data into a bit stream. The bit stream can be transmitted and/or stored, and subsequently decoded back into the spatial domain, where the image/video can be viewed or used in other applications such as machine learning. Conventionally, the decoding process is essentially the inverse of the encoding process, and includes entropy decoding of the bit stream into frames of data, dequantization of the frames, and inverse DCT transformation of the dequantized data.

Thus, in essence, image/video data is processed from the spatial (e.g., RGB) domain into the frequency (DCT) domain when it is encoded, then processed back from the frequency domain to the spatial domain when it is decoded.

Other efficiencies are incorporated into the encoding and decoding processes for frames of video data. For example, the frames of video data can be encoded as I-frames and P-frames. An I-frame includes a complete image, while a P-frame includes only the changes in an image relative to another (reference) frame. Instead of including the data for an object in each frame in which the object appears, the data for the object is included in a reference frame, and a motion vector is encoded to indicate the position of the object in another frame based on the position of the object in the reference frame. In the decoding process, the video data is reconstructed in the spatial domain using the encoded I-frames, P-frames, and motion vectors.

For artificial intelligence applications, machine learning (including deep learning) tasks are performed in the spatial domain as mentioned above. This requires fully decoding videos back to the spatial (e.g., RGB) domain, which increases the latency and power consumption associated with reconstruction of videos in the spatial domain, and can also increase the latency and power consumption associated with deep neural network computing.

### SUMMARY

In embodiments according to the present invention, transformed domain information (discrete cosine transform, DCT, information) is reconstructed from information in an encoded stream of video frames. In those embodiments, DCT information for a block can be estimated from an adjacent block of the same frame, DCT information for a block can be estimated from a block in a different frame, and DCT information for a block can be estimated from a block in a different frame using a motion vector.

Consequently, machine learning tasks can be performed without decoding videos back to the spatial (e.g., red-green-blue) domain. This is particularly useful in deep learning tasks where frame reconstruction in the spatial domain is not needed, such as in summaries of video surveillance and facial recognition. Performing deep learning tasks in the DCT domain reduces the latency and power consumption associated with reconstruction of videos in the spatial domain, and can also reduce the latency and power consumption associated with deep neural network computing.

These and other objects and advantages of the various embodiments of the present invention will be recognized by those of ordinary skill in the art after reading the following detailed description of the embodiments that are illustrated in the various drawing figures.

### BRIEF DESCRIPTION OF DRAWINGS

The accompanying drawings, which are incorporated in and form a part of this specification and in which like numerals depict like elements, illustrate embodiments of the present disclosure and, together with the detailed description, serve to explain the principles of the disclosure.

FIG. 1 is a block diagram illustrating an example of a system upon which embodiments according to the present invention can be implemented.

FIG. 2 illustrates a process for decoding an encoded video stream in embodiments according to the present invention.

FIGS. 3A and 3B illustrate systems or processors for encoding and decoding a video stream in embodiments according to the present invention.

FIG. 4A illustrates an example of intra-prediction of discrete cosine transform (DCT) information for a block in a frame using DCT information from another block in the same frame, in embodiments according to the present invention.

FIG. 4B illustrates an example of inter-prediction of DCT information for a block in a frame using DCT information from another block in another (reference) frame, in embodiments according to the present invention.

FIG. 4C illustrates an example of inter-prediction of DCT information for a block in a frame using DCT information from another block in another (reference) frame and also using a motion vector that points to the block in the other (reference) frame, in embodiments according to the present invention.

FIG. 4D illustrates an example of inter-prediction of DCT information for a block in a frame using DCT information from another (second) block in another (first reference) frame and from yet another (third) block in yet another (second reference) frame, in embodiments according to the present invention.

FIG. 4E illustrates an example of inter-prediction of DCT information for a block in a frame using DCT information from another (second) block in another (first reference) frame and from yet another (third) block in yet another (second reference) frame, and also using a motion vector, in embodiments according to the present invention.

FIG. 5 is a flowchart of a method of reconstructing transformed domain information in an encoded video stream in an embodiment according to the present invention.

### DETAILED DESCRIPTION

Reference will now be made in detail to the various embodiments of the present disclosure, examples of which are illustrated in the accompanying drawings. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

Some portions of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those utilizing physical manipulations of physical quantities. Usually, although not necessarily, these quantities take the form of electrical or magnetic signals capable of being stored, transferred, combined, compared, and otherwise manipulated in a computer system. It has proven convenient at times, principally for reasons of common usage, to refer to these signals as transactions, bits, values, elements, symbols, characters, samples, pixels, or the like.

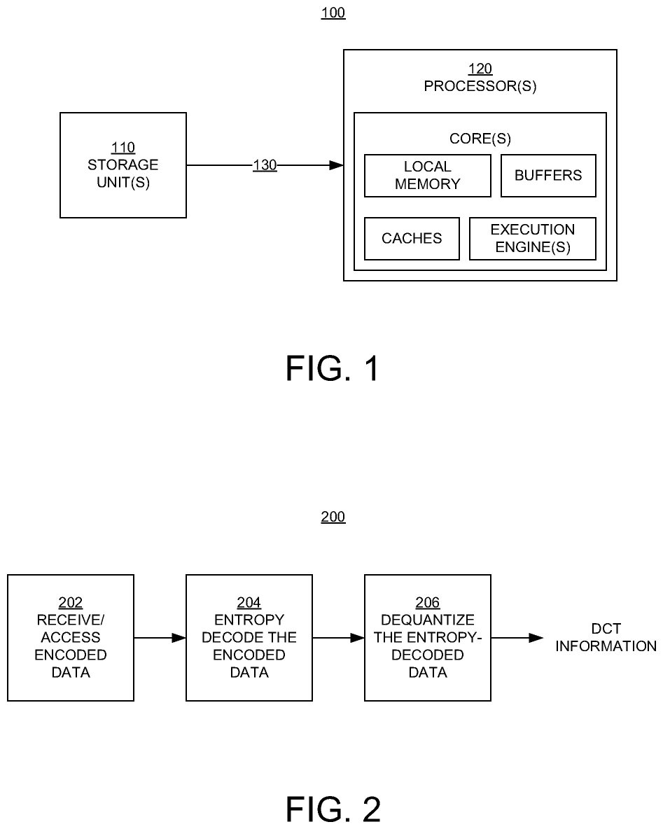

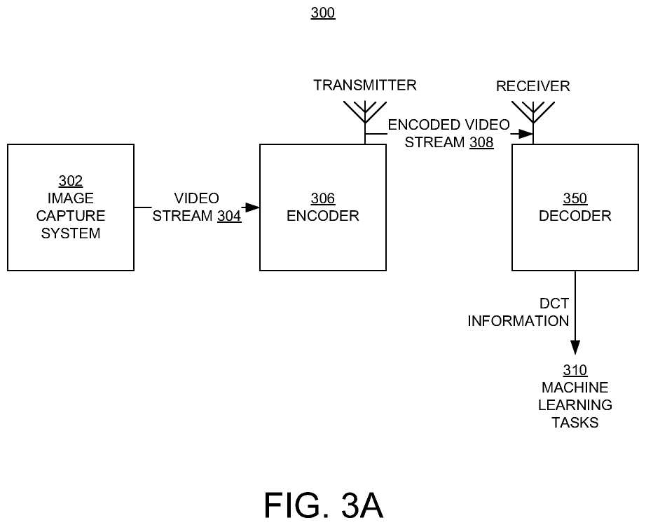

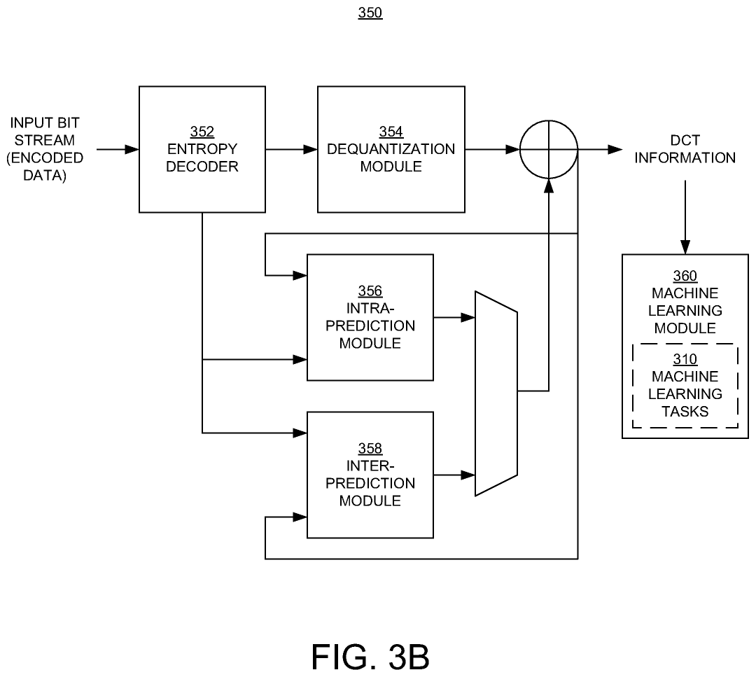

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “receiving,” “accessing,” “determining,” “using,” “encoding,” “decoding,” “quantizing,” “dequantizing,” “discrete cosine transforming,” “inverse discrete cosine transforming,” “adding,” “duplicating,” “copying,” or the like, refer to actions and processes (e.g., flowchart 500 of FIG. 5) of an apparatus or computer system or similar electronic computing device or processor (e.g., the system or processors 100, 300, and 350 of FIGS. 1, 3A, and 3B). A computer system or similar electronic computing device manipulates and transforms data represented as physical (electronic) quantities within memories, registers or other such information storage, transmission or display devices.

Embodiments described herein may be discussed in the general context of computer-executable instructions residing on some form of computer-readable storage medium, such as program modules, executed by one or more computers or other devices. By way of example, and not limitation, computer-readable storage media may comprise non-transitory computer storage media and communication media. Generally, program modules include routines, programs, objects, components, data structures, etc., that perform particular tasks or implement particular abstract data types. The functionality of the program modules may be combined or distributed as desired in various embodiments.

Computer storage media includes volatile and nonvolatile, removable and non-removable media implemented in any method or technology for storage of information such as computer-readable instructions, data structures, program modules or other data. Computer storage media includes, but is not limited to, random access memory (RAM), read only memory (ROM), electrically erasable programmable ROM (EEPROM), flash memory (e.g., an SSD) or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information and that can accessed to retrieve that information.

Communication media can embody computer-executable instructions, data structures, and program modules, and includes any information delivery media. By way of example, and not limitation, communication media includes wired media such as a wired network or direct-wired connection, and wireless media such as acoustic, radio frequency (RF), infrared and other wireless media. Combinations of any of the above can also be included within the scope of computer-readable media.

FIG. 1 is a block diagram illustrating an example system 100 upon which embodiments according to the present invention can be implemented. In general, the system 100 is a type of system that can be used with or in a system or processor (e.g., the systems or processors 300 and 350 of FIGS. 3A and 3B) that encodes and/or decodes graphical data, which includes image data and video data.

In the example of FIG. 1, the system 100 can include one or more storage units (computer storage media) 110 and a processor 120 communicatively coupled by a communication interface 130. The processor 120 can include one or more cores, and each core may include local memory that may be distributed among the cores, one or more buffers and/or caches, and one or more execution engines. The term “memory” may be used herein to refer to the buffers and/or caches and/or local memory. The communication interface 130 can include a wired network communication link, a wireless network communication link, a data bus, or the like.

FIG. 2 illustrates a process 200 for decoding (decompressing) an encoded (compressed) video stream in embodiments according to the present invention.

In block 202 of FIG. 2, encoded video data is received from another device or accessed from computer system memory, for example.

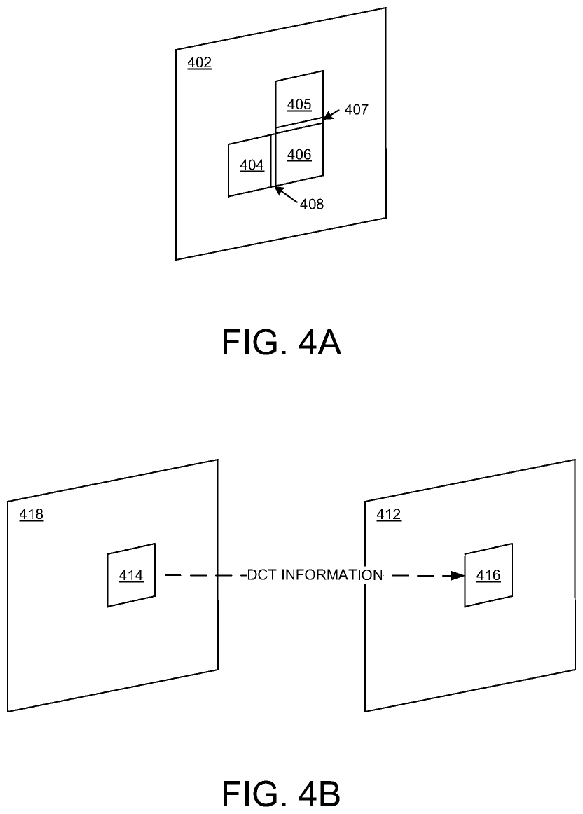

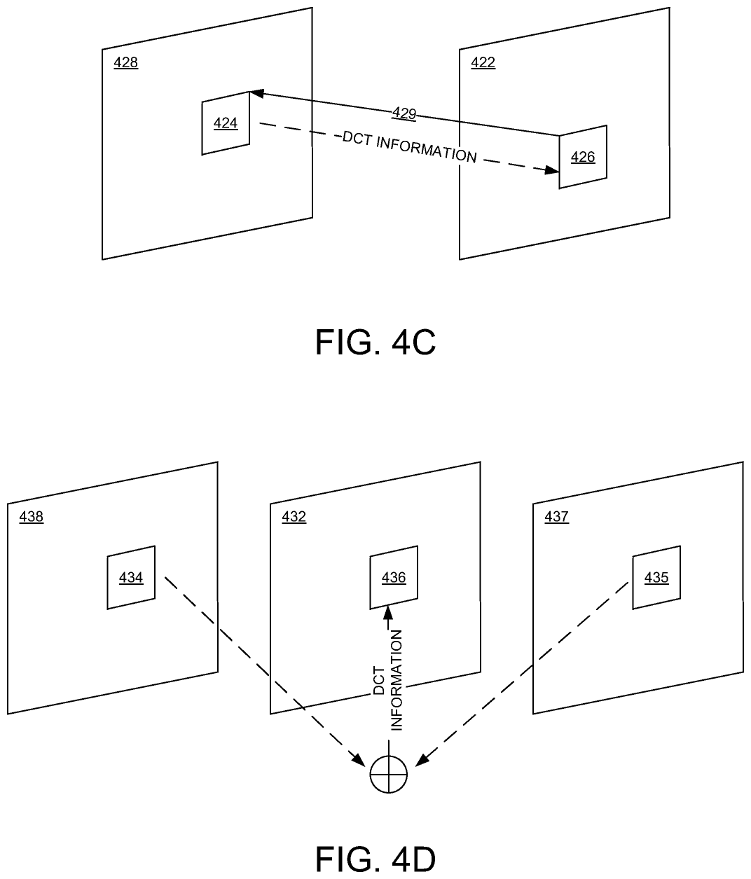

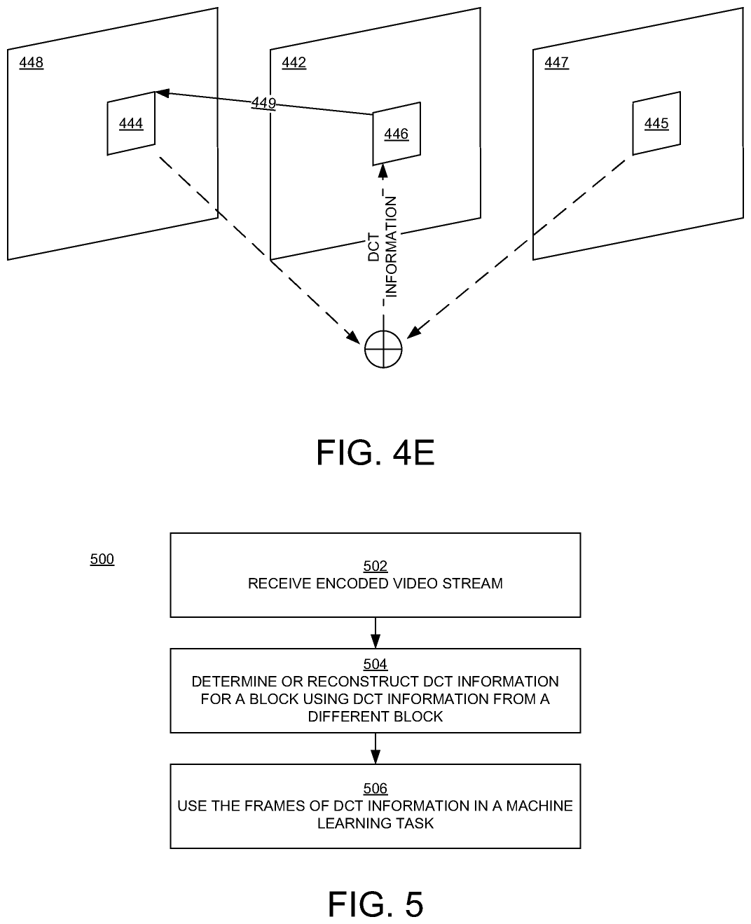

In block 204, the encoded data is entropy decoded. In block 206, the entropy-decoded data is dequantized. The dequantized data consists of frames of data, each of the frames including blocks. It may be necessary to reconstruct or estimate DCT information for some of those blocks. In embodiments according to the present invention, DCT information can be estimated from adjacent blocks of the same frame (intra-frame prediction), DCT information can be estimated from different frames (inter-frame prediction), and DCT information can be estimated from different frames using motion vectors (inter-frame prediction), as described further below in conjunction with FIGS. 3A and 3B and FIGS. 4A-4E.

Reconstructing DCT information is different from conventional approaches for reconstructing video data. In conventional approaches, the DCT information that is present after dequantization is further processed to determine pixel values in the spatial domain. In contrast, in embodiments according to the present invention, the DCT information that is present after dequantization is used to determine additional DCT information. Furthermore, in embodiments according to the present invention, the inverse DCT (IDCT) operation is not performed.

FIG. 3A illustrates a system 300 for processing (encoding and decoding) video data in embodiments according to the present invention. FIG. 3A illustrates examples of applications where deep learning tasks are performed for video images when transmission is needed, such as (but not limited to) video surveillance and facial recognition.

In the example of FIG. 3A, video data is captured using an image capture system 302 that includes, for example, an image capture device (e.g., a camera). The stream 304 of video data is provided to an encoder 306 that performs functions such as, but not limited to, conversion from the color (red-green-blue) domain into luma-chroma color space, transformation into the DCT domain, quantization, and entropy encoding. The encoded video stream 308 can then be transmitted to a system or processor (decoder) 350 for decoding according to the process 200 of FIG. 2. The decoder 350 is described further below. Significantly, the decoder 350 does not perform the IDCT operation. The output of the decoder 350 can be used in deep learning or machine learning tasks 310.

FIG. 3B illustrates the decoder 350 for decoding an encoded video stream on the receiving side of the system 300, in embodiments according to the present invention. The decoder 350 can be implemented using the processor 120 of FIG. 1, for example.

The decoder 350 includes an entropy decoder 352 that receives an encoded stream of video frames and outputs entropy-decoded data. The decoder 350 also includes a dequantization module 354 that receives the entropy-decoded data and outputs a stream that includes frames of data that include DCT information.

The decoder 350 also includes prediction modules including an intra-prediction module 356 and an inter-prediction module 358. The intra-prediction module 356 determines the DCT information for a block in a frame using DCT information from another block in the same frame (FIG. 4A). The inter-prediction module 358 determines the DCT information for a block in a frame using DCT information from another block in another (reference) frame (FIG. 4B). The inter-prediction module 358 also determines the DCT information for a block in a frame using DCT information from another block in another (reference) frame and also using a motion vector that points to the block in the other (reference) frame (FIG. 4C). The inter-prediction module 358 also determines the DCT information for a block in a frame using DCT information from another (second) block in another (first reference) frame and from yet another (third) block in yet another (second reference) frame (FIGS. 4D and 4E).

In an embodiment, the decoder 350 of FIG. 3B also includes a machine learning module 360 that uses the frames of DCT information in a deep learning or machine learning task 310. That is, significantly and advantageously, inverse DCT operations are not performed on the data that is input to the machine learning module 360.

In embodiments, the decoder 350 is implemented as or by executing a non-transitory computer-readable storage medium that includes the modules 352, 354, 356, 358, and 360 as computer-executable modules.

FIG. 4A illustrates an example of intra-prediction of DCT information for a block 406 in a frame using DCT information from another block in the same frame 402, in embodiments according to the present invention. In the example of FIG. 4A, the DCT information for the block 406 can be estimated using the DCT information for the block 404 and/or the DCT information for the block 405. In an embodiment, the DCT information for the row 407 of pixels in the block 405 that is adjacent to the block 406 can be copied and duplicated for each row of pixels in the block 406. In other words, the DCT information in the row 407 is repeated in each row of the block 406. In another embodiment, the DCT information for the column 408 of pixels in the block 404 that is adjacent to the block 406 can be copied and duplicated for each column of pixels in the block 406. In other words, the DCT information in the column 408 is repeated in each column of the block 406. The present invention is not limited to those embodiments.

FIG. 4B illustrates an example of inter-prediction of DCT information for a block 416 in a frame 412 using DCT information from another block 414 in another (reference) frame 418, in embodiments according to the present invention. In an embodiment, the DCT information in the block 414 is duplicated for the block 416.

FIG. 4C illustrates an example of inter-prediction of DCT information for a block 426 in a frame 422 using DCT information from another block 424 in another (reference) frame 428 and also using a motion vector 429 that points to the block 424 in the reference frame 428, in embodiments according to the present invention. In an embodiment, the position of the block 426 in the frame 422 is determined using the motion vector 429, and the DCT information in the block 424 is duplicated for the block 426.

FIG. 4D illustrates an example of inter-prediction of DCT information for a block 436 in a frame 432 using DCT information from another (second) block 434 in another (first reference) frame 438 and from yet another (third) block 435 in yet another (second reference) frame 437, in embodiments according to the present invention. In an embodiment, the DCT information in the blocks 434 and 435 is averaged, added, or interpolated to determine the DCT information for the block 436.

FIG. 4E illustrates an example of inter-prediction of DCT information for a block 446 in a frame 442 using DCT information from another (second) block 444 in another (first reference) frame 448 and from yet another (third) block 445 in yet another (second reference) frame 447, and also using a motion vector 449, in embodiments according to the present invention. In an embodiment, the position of the block 446 in the frame 442 is determined using the motion vector 449, and the DCT information in the blocks 444 and 445 is averaged, added, or interpolated to determine the DCT information for the block 446.

FIG. 5 is a flowchart 500 of a method of reconstructing transformed domain (e.g., DCT) information in an encoded video stream in an embodiment according to the present invention. All or some of the operations represented by the blocks in the flowchart 500 can be implemented as computer-executable instructions residing on some form of non-transitory computer-readable storage medium, and performed by a system such as the system 100 of FIG. 1 that is utilized in, for example, the systems or processors 300 and 350 of FIGS. 3A and 3B.

In block 502 of FIG. 5, a stream of frames of video data is received (after entropy decoding and dequantization). The frames include blocks.

In block 504, DCT information is reconstructed or determined for a block in a frame using DCT information from another (different) block. More specifically, for example. DCT information for a block can be estimated from an adjacent block of the same frame, DCT information for a block can be estimated from a block in a different frame, and DCT information for a block can be estimated from a block in a different frame using a motion vector.

In block 506, the frames of DCT information are used in a machine learning task.

In summary, embodiments according to the invention enable machine learning tasks to be performed without fully decoding videos back to the spatial (e.g., RGB) domain. This is particularly useful in deep learning tasks where frame reconstruction in the spatial domain is not needed, such as in summaries of video surveillance and facial recognition. Performing deep learning tasks in the DCT domain reduces the latency and power consumption associated with reconstruction of videos in the spatial domain, and can also reduce the latency and power consumption associated with deep neural network computing.

Embodiments according to the present invention are discussed in the context of DCT information; however, the present invention is not so limited. For example, the frequency domain components can be components of Fourier Transform image data, components of Wavelet Transform image data, components of Discrete Wavelet Transform image data, components of Hadamard transform image data, or components of Walsh transform image data.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered as examples because many other architectures can be implemented to achieve the same functionality.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While various embodiments have been described and/or illustrated herein in the context of fully functional computing systems, one or more of these example embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. These software modules may configure a computing system to perform one or more of the example embodiments disclosed herein. One or more of the software modules disclosed herein may be implemented in a cloud computing environment. Cloud computing environments may provide various services and applications via the Internet. These cloud-based services (e.g., software as a service, platform as a service, infrastructure as a service, etc.) may be accessible through a Web browser or other remote interface. Various functions described herein may be provided through a remote desktop environment or any other cloud-based computing environment.

Although the subject matter has been described in language specific to structural features and/or methodological acts, it is to be understood that the subject matter defined in the disclosure is not necessarily limited to the specific features or acts described above. Rather, the specific features and acts described above are disclosed as example forms of implementing the disclosure.

Embodiments according to the invention are thus described. While the present disclosure has been described in particular embodiments, it should be appreciated that the invention should not be construed as limited by such embodiments, but rather construed according to the following claims.

1. A method, comprising:
receiving a stream comprising a plurality of encoded frames of a video stream, wherein the plurality of encoded frames comprises encoded frames comprising a plurality of blocks;
entropy decoding and dequantizing the plurality of encoded frames to produce discrete cosine transform (DCT) information for a plurality of blocks of a plurality of entropy decoded and dequantized frames; and
determining DCT information for a first block in a first frame of the plurality of entropy decoded and dequantized frames using the DCT information produced from said entropy decoding and dequantizing for a different block.

2. The method of claim 1, wherein said determining comprises determining the DCT information for the first block in the first frame using the DCT information produced from said entropy decoding and dequantizing for a second block in the first frame.

3. The method of claim 1, wherein said determining comprises determining the DCT information for the first block in the first frame using the DCT information produced from said entropy decoding and dequantizing for a second block in a second frame of the plurality of entropy decoded and dequantized frames.

4. The method of claim 1, wherein said determining comprises determining the DCT information for the first block in the first frame using the DCT information produced from said entropy decoding and dequantizing for a second block in a second frame of the plurality of entropy decoded and dequantized frames and a motion vector that points to the second block.

5. The method of claim 1, wherein said determining comprises determining the DCT information for the first block in the first frame using the DCT information produced from said entropy decoding and dequantizing for a second block in a second frame of the plurality of entropy decoded and dequantized frames and the DCT information produced from said entropy decoding and dequantizing for a third block in a third frame of the plurality of entropy decoded and dequantized frames.

6. The method of claim 1, further comprising, after said receiving and said determining, using frames of DCT information in a machine learning task.

7. The method of claim 1, wherein the plurality of encoded frames is quantized using a DCT matrix, quantized using a quantization matrix, and encoded before said receiving.

8. A system, comprising:
a processor; and
memory coupled to the processor, the memory having instructions stored therein that, when executed with the processor, cause the system to perform a method comprising:
receiving a stream comprising a plurality of encoded frames of a video stream, wherein the plurality of encoded frames comprises encoded frames comprising a plurality of blocks;
entropy decoding and dequantizing the plurality of encoded frames to produce discrete cosine transform (DCT) information for a plurality of blocks of a plurality of entropy decoded and dequantized frames; and
determining DCT information for a first block in a first frame of the plurality of entropy decoded and dequantized frames using the DCT information produced from said entropy decoding and dequantizing for a different block.

9. The system of claim 8, wherein the method further comprises determining the DCT information for the first block in the first frame using the DCT information produced from said entropy decoding and dequantizing for a second block in the first frame.

10. The system of claim 8, wherein the method further comprises determining the DCT information for the first block in the first frame using the DCT information produced from said entropy decoding and dequantizing for a second block in a second frame of the plurality of entropy decoded and dequantized frames.

11. The system of claim 8, wherein the method further comprises determining the DCT information for the first block in the first frame using the DCT information produced from said entropy decoding and dequantizing for a second block in a second frame of the plurality of entropy decoded and dequantized frames and a motion vector that points to the second block.

12. The system of claim 8, wherein the method further comprises determining the DCT information for the first block in the first frame using the DCT information produced from said entropy decoding and dequantizing for a second block in a second frame of the plurality of entropy decoded and dequantized frames and the DCT information produced from said entropy decoding and dequantizing for a third block in a third frame of the plurality of entropy decoded and dequantized frames.

13. The system of claim 8, wherein the method further comprises, after said receiving and said determining, using frames of DCT information in a machine learning task.

14. The system of claim 8, wherein the plurality of encoded frames is quantized using a DCT matrix, quantized using a quantization matrix, and encoded before said receiving.

15. A non-transitory computer-readable storage medium comprising computer-executable modules, the modules comprising:
an entropy decoder that receives an encoded stream of video frames and outputs entropy-decoded data determined from the encoded stream;
a dequantization module that receives the entropy-decoded data and outputs discrete cosine transform (DCT) information for a plurality of blocks of a plurality of entropy decoded and dequantized frames; and
prediction modules that determine DCT information for a first block in a first frame of the plurality of entropy decoded and dequantized frames using the DCT information output from the dequantization module for a different block of the plurality of blocks.

16. The non-transitory computer-readable storage medium of claim 15, wherein the prediction modules comprise an intra-prediction module that determines the DCT information for the first block in the first frame using the DCT information output from the dequantization module for a second block in the first frame.

17. The non-transitory computer-readable storage medium of claim 15, wherein the prediction modules comprise an inter-prediction module that determines the DCT information for the first block in the first frame using the DCT information output from the dequantization module for a second block in a second frame of the plurality of frames.

18. The non-transitory computer-readable storage medium of claim 15, wherein the prediction modules comprise an inter-prediction module that determines the DCT information for the first block in the first frame using the DCT information output from the dequantization module for a second block in a second frame of the plurality of frames and a motion vector that points to the second block.

19. The non-transitory computer-readable storage medium of claim 15, wherein the prediction modules comprise an inter-prediction module that determines the DCT information for the first block in the first frame using the DCT information output from the dequantization module for a second block in a second frame of the plurality of frames and the DCT information output from the dequantization module for a third block in a third frame of the plurality of frames.

20. The non-transitory computer-readable storage medium of claim 15, further comprising a machine learning module that uses frames of DCT information in a machine learning task.

21. A processor, comprising:
memory; and
a decoder that: accesses, from the memory, a plurality of encoded frames of a video stream, wherein the plurality of encoded frames comprises encoded frames comprising a plurality of blocks, performs entropy decoding and dequantization of the plurality of encoded frames to produce discrete cosine transform (DCT) information for a plurality of blocks of a plurality of entropy decoded and dequantized frames, and also determines DCT information for a first block in a first frame of the plurality of entropy decoded and dequantized frames using the DCT information produced from said entropy decoding and dequantization for a different block.

22. The processor of claim 21, wherein the decoder determines the DCT information for the first block in the first frame using the DCT information produced from said entropy decoding and dequantization for a second block in the first frame.

23. The processor of claim 21, wherein the decoder determines the DCT information for the first block in the first frame using the DCT information produced from said entropy decoding and dequantization for a second block in a second frame of the plurality of frames.

24. The processor of claim 21, wherein the decoder determines the DCT information for the first block in the first frame using the DCT information produced from said entropy decoding and dequantization for a second block in a second frame of the plurality of frames and a motion vector that points to the second block.

25. The processor of claim 21, wherein the decoder determines the DCT information for the first block in the first frame using the DCT information produced from said entropy decoding and dequantization for a second block in a second frame of the plurality of frames and the DCT information produced from said entropy decoding and dequantization for a third block in a third frame of the plurality of frames.

26. The processor of claim 21, configured to use frames of DCT information in a machine learning task.
